(19) United States
(12) Patent Application Publication
(10) Pub. No.: US 2011/0309279 A1
(43) Pub. Date: Dec. 22, 2011

(54) FLOW VALVE WITH INTEGRAL SPRING AND SEAL

(75) Inventors: James L. Richards, Dassel, MN (US); Loren J. Brelje, Glencoe, MN (US); Dean A. Ruzicka, Winsted, MN (US)

(73) Assignee: David S. Smith America, Inc. DBA Worldwide Dispensers, Lester Prairie, MN (US)

(21) Appl. No.: 13/165,040

(22) Filed: Jun. 21, 2011

Related U.S. Application Data
(60) Provisional application No. 61/356,926, filed on Jun. 21, 2010.

(51) Int. Cl. F16L 37/42; F16K 31/44

(52) U.S. Cl. 251/149.7; 137/614.14

(57) ABSTRACT

Embodiments of the present invention are designed to interface between a package, either rigid or flexible and an apparatus to push a seal valve from the housing. Once the container is inserted into the “nest” with valve, opened fluid flow is achieved. Once the container with the valve is removed from the “nest” the valve will self close, with no operator interaction to stop flow of the product.

### CROSS-REFERENCE TO RELATED APPLICATIONS

This Application claims priority to U.S. Provisional Application No. 61/356,926, filed on Jun. 21, 2010, the contents of which are herein incorporated by reference.

### STATEMENT REGARDING FEDERALLY SPONSORED RESEARCH

Not Applicable.

### FIELD OF THE INVENTION

Embodiments of the present invention generally relate to dispensing fluids. Particularly, embodiments of the present invention relate to dispensing valves for fluid containers. More particularly, embodiments of the present invention relate to a dispensing valve having fewer components than prior valves and requiring no operator interaction, beyond detachment of the valve assembly, to stop the flow of the fluid.

### BACKGROUND

A variety of metal coil spring actuated dispensing valves for dispensing fluids from a container are known in the art. The problem of leaking fluid in present products has been attempted to be solved by adding O-rings to the product. This adds an additional cost to the product not only in the O-ring component itself, but in the application of the O-ring. It would be desirable to reduce the cost of the traditional ball and spring valve designs. Further, it would be desirable to remove the metal from the valve assembly as the traditional ball and spring valve has a history of leaking fluid due to the need of the ball to be concentric with a longitudinal axis of the valve assembly. Any irregularity of the ball allows potential for leaking of fluids. It would be desirable to have a fluid dispensing design which could offer an over cap to prevent accidental opening during transit.

### SUMMARY OF THE INVENTION

Embodiments of the present invention are designed to interface between a package, either rigid or flexible, including bag-in-box and an apparatus to push a seal valve from the housing. Once the container is inserted into the “nest” with valve, opened fluid flow is achieved. Once the container with the valve is removed from the “nest” the valve will self close, with no operator interaction to stop flow of the product.

In some embodiments, a fluid dispensing valve has an open configuration, wherein fluid is permitted to flow, and a closed configuration, wherein fluid is prevented from flowing. In some embodiments, the fluid dispensing valve comprises a housing and a seal disposed within the housing. The seal comprises a resilient member and the resilient member comprises a base and a stem. The base comprises a dome and the stem extends from the dome and terminates at a closed distal end. In some embodiments, at least a portion of the stem sealingly engages the housing when the fluid dispensing valve is in the closed configuration.

In some embodiments, the seal of the fluid dispensing valve comprises a gasket that is concentrically disposed around the base of the seal.

In some embodiments, the gasket is attached to the base via a plurality of standoff members.

In some embodiments, the dome of the seal comprises a sidewall having a variable thickness.

In some embodiments, the housing of the fluid dispensing valve comprises a plurality of retaining legs.

In some embodiments, the base comprises a proximal end and the retaining legs are folded over at least a portion of the proximal end of the base.

In some embodiments, the seal of the fluid dispensing valve is moveable between an extended configuration and a compressed configuration and the housing defines a mating surface. In the extended configuration, at least a portion of the stem contacts the mating surface and, in the compressed configuration, the stem does not contact the housing.

In some embodiments, the fluid dispensing valve comprises a dust cap, the dust cap having a tear strip.

In some embodiments, the stem of the fluid dispensing valve comprises a frusto-conical portion.

In some embodiments, the seal comprises a thermoplastic elastomer material.

In some embodiments a fluid dispensing valve comprises a housing defining an interface cavity and a seal cavity. The fluid dispensing valve further comprises a seal. The seal comprises a base, a stem extending from the base, and a gasket attached to the base. The stem is disposed within the seal cavity and the gasket is disposed within the interface cavity. The stem is moveable within the seal cavity from an extended position to a compressed position. In the extended position, the base is dome-shaped and, in the compressed position, the base is elastically deformed to define an annular crease.

In some embodiments, the housing of the fluid dispensing valve comprises a plurality of retaining legs and the base of the seal comprises a proximal end. The retaining legs are folded over at least a portion of the proximal end of the base.

In some embodiments, the housing comprises internal threads extending into the interface cavity.

In some embodiments, the base of the seal comprises a sidewall having a non-uniform thickness.

In some embodiments, the stem comprises a beveled surface and the housing comprises a mating surface. A portion of the beveled surface contacts the mating surface when the stem is in the extended position.

In some embodiments, the stem comprises a distal end and the distal end is dished.

In some embodiments, a fluid dispensing assembly comprises a container, a fluid dispensing valve, and a seal. The container has an outlet hub and the fluid dispensing valve comprises a housing. The housing defines an interface cavity and a seal cavity. The housing further comprises a mating surface. In some embodiments, the seal is disposed within the seal cavity. Further, the interface cavity defines threads, the threads being threadingly engaged to the outlet hub. In some embodiments, the seal comprises a base and as stem. The base comprises a dome, and the stem extends from the dome and terminates at a closed distal end. The stem comprises a beveled surface, the beveled surface of the stem sealingly engaging the mating surface of the seal cavity.

### DESCRIPTION OF THE DRAWINGS

FIG. 1 shows an exploded upper level view of an embodiment of a dispensing valve.

FIG. 2 shows a cutaway view of an embodiment of the dispensing valve.

FIG. 2A shows a detailed cross-sectional view of a portion of the embodiment of the dispensing valve of FIG. 2.

FIG. 3A shows an underside view of an embodiment of the housing with retention legs unfolded.

FIG. 3B shows an underside view of an embodiment of the housing and seal having retention legs folded over.

FIG. 4 shows a container, an embodiment of the dispensing valve in a closed position, and an adjacent dispensing line, all in cutaway.

FIG. 5 shows a container with an embodiment of the dispensing valve in an open position.

FIG. 5A shows a detailed cross-sectional view of the embodiment of FIG. 5.

FIG. 6 shows an upper level view of an embodiment of the seal.

FIG. 7 shows an underside view of an embodiment of the seal.

FIG. 8A shows a cutaway view of an embodiment of the seal in an extended position.

FIG. 8B shows a cutaway view of the embodiment of the seal of FIG. 8A with the seal in a compressed position.

FIG. 9A shows a cutaway view of an embodiment of the dispensing valve, with the seal in the extended position.

FIG. 9B shows a cutaway view of the embodiment of FIG. 9A of the dispensing valve, with the seal in the compressed position.

FIG. 10 shows an underside view of an embodiment of the dispensing valve.

### DETAILED DESCRIPTION

The following discussion is presented to enable a person skilled in the art to make and use the present teachings. Various modifications to the illustrated embodiments will be readily apparent to those skilled in the art, and the generic principles herein may be applied to other embodiments and applications without departing from the present teachings. Thus, the present teachings are not intended to be limited to embodiments shown, but are to be accorded the widest scope consistent with the principles and features disclosed herein. The following detailed description is to be read with reference to the figures, in which like elements in different figures have like reference numerals. The figures depict selected embodiments and are not intended to limit the scope of the present teachings. Skilled artisans will recognize the examples provided herein have many useful alternatives and fall within the scope of the present teachings.

Embodiments of the present invention comprise a fluid dispensing valve including a housing and a seal. The dispensing valve is designed to interface between a package, either rigid, semi-rigid, or bag and an apparatus to push the seal away from the housing, something similar to a nest with a center post, which allows package content to dispense once pressed up against the center post. Once the package is removed from the “nest” the package contents stop flowing.

Embodiments of the present invention reduce the number of components from prior designs and eliminate the use of separate O-rings in sealing. Embodiments of the present invention also eliminate the use of a metal spring from that of the prior design. The known design of a spring and ball requires two pieces, where embodiments of the present invention replace the spring and ball design with a polymer dome spring with an integrated seal, which is only one piece, thus reducing the materials cost of the assembly and the cost to manufacture. Embodiments of the present invention use a “point-to-flat” sealing system with a soft material to hard material allowing the soft material to conform to the hard material, thereby maximizing sealing between the soft material and hard material.

Embodiments of the present invention provide a robust sealing mechanism to ensure a fluid dispensing product does not leak. The seal design is reduced to three pieces in contrast to known designs which can require five to six pieces. These extra components not only add cost in materials, but also add complexity to the assembly process. Further, embodiments of the present invention remove any metal from the valve assembly, increasing the recyclability of the product and removing metal from the fluid flow path.

Embodiments of the present invention disclose a dispensing valve to control fluid flow between a container and an opening apparatus. The dispensing valve is self-closing to stop product flow; the dispensing valve opens when pressure is applied to the seal, pushing the seal away from the housing. Embodiments of the present invention can replace the traditional spring and ball valve.

Embodiments of the present invention provide a dust cap over the activating end of the dispensing valve to protect against contaminants on the dispensing interface. Further, the dust cap provides transit protection to prevent accidental activation of the valve during transit.

Current design uses ultrasonic staking of the retaining legs in the body to retain the spring seal. Other methods including additional components can be used to retain the spring seal into the housing.

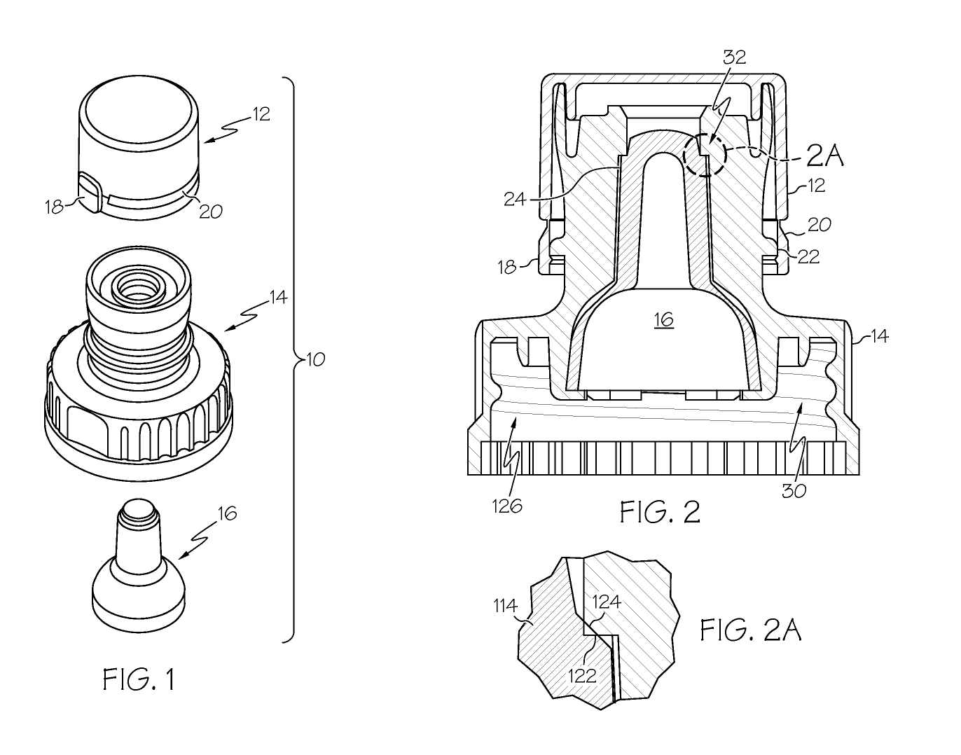

With reference to FIG. 1, an exploded upper level view of an embodiment of a dispensing valve of the present invention is shown. Flow valve or dispensing valve 10 can have a dust cap 12, housing 14 and spring/seal 16. Dust cap 12, can be made of any polymer, such as high density polyethylene, without departing from the spirit of the invention. Dust cap 12 can have a tear strip 18 for ease of removal of dust cap 12. As can be seen from FIG. 1, a channel 20 on cap 12 allows tear strip 18 to be torn around the outer circumference of dust cap 12, thus allowing dust cap 12 to be removed from housing 14.

In some embodiments, spring/seal 16 is formed by an integral material and is made of any suitable polymer, such as TPE (thermoplastic elastomers), without departing from the spirit of the invention. Further, housing 14 can be made of almost any polymer, such as polypropylene, without departing from the spirit of the invention. Housing 14 can also have a retention feature, discussed in more detail below, modified after the housing 14 has been molded, which retains the spring/seal 16 upon assembly of the components.

With reference to FIG. 2, a side cutaway view of a dispensing valve 10 in an embodiment of the present invention is shown. As assembled, and in cutaway, it is evident that the housing 14 has internal threads 30 for rotating housing 14 onto a container. Dust cap 12 is shown being held into place on housing 14 by a lip 22 on housing 14. Tear strip 18 holds dust cap 12 onto housing 14 by lip 22. When tear strip 18 is removed there is nothing holding dust cap 12 onto body 14 and the dust cap 12 can be removed from the housing 14. Engaged within channel or seal cavity 24 of housing 14 is spring/seal 16.

In some embodiments, the spring/seal 16 has a sealing point 32 wherein the spring/seal 16 contacts the housing 14. Contact between the spring/seal 16 and housing 14 at sealing point 32 prevents any fluid from exiting housing 14 or the container, as discussed in greater detail below. Since spring/seal 16 is made of a soft, pliable material, as opposed to housing 14, which is a harder, rigid material, a tight seal can be formed between the spring/seal 16 and the housing 14. In some embodiments, the spring/seal 16 is made of a material having a 34 shore D durometer and, in some embodiments, the housing 14 is made of a material having a durometer of 100 on the Rockwell R-scale. Further, in some embodiments, the spring/seal 16 is a copolyester elastomer, for example Arnitel® EM 400 thermoplastic elastomer (TPE) with a 34 shore D durometer. In some embodiments, the housing 14 is a polypropylene, for example Flint Hills Resources® polypropylene AP5520-HA with a durometer of 100 on the Rockwell R-scale.

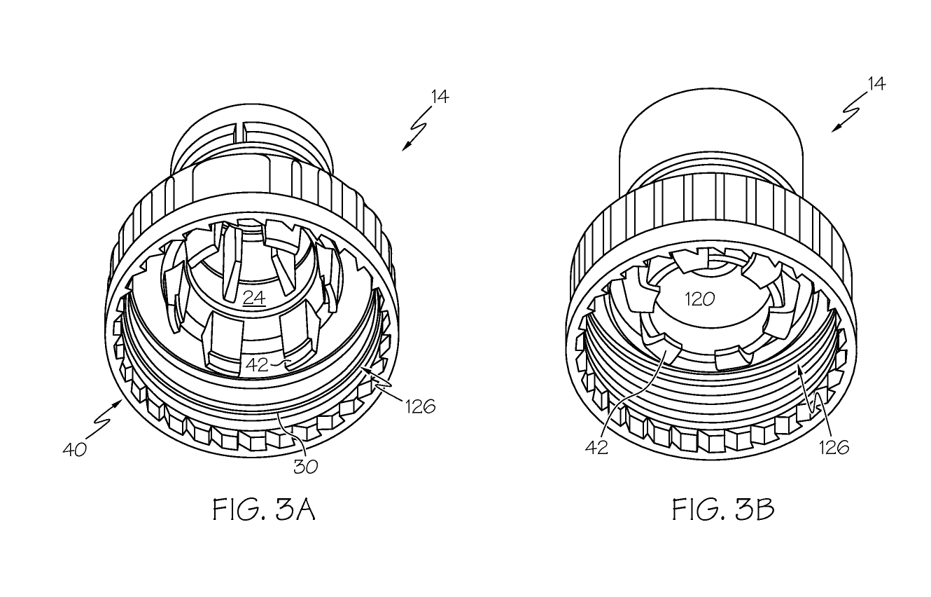

With reference to FIG. 3A, an underside view of a housing 14 in an embodiment of the present invention is shown. In FIG. 3A, the dust cap 12 has not yet been added to the housing 14. On the underside 40 of housing 14 lie retaining legs 42 in a down or unfolded position. Once spring/seal 16 is inserted into channel or seal cavity 24, retaining legs 42 can be bent over, as shown in FIG. 3B, in order to support the underside of spring/seal 16 and retain the spring/seal 16 within the housing 14. In some embodiments, for example as shown in FIG. 3B, the retaining legs 42 are bent over the proximal end 120 of the spring/seal 16. Retaining legs 42 can be bent over in most any fashion, such as manually or with ultrasonic welding, without departing from the scope of the disclosure. In FIG. 3B, the housing 14 is shown with dust cap 12 thereon.

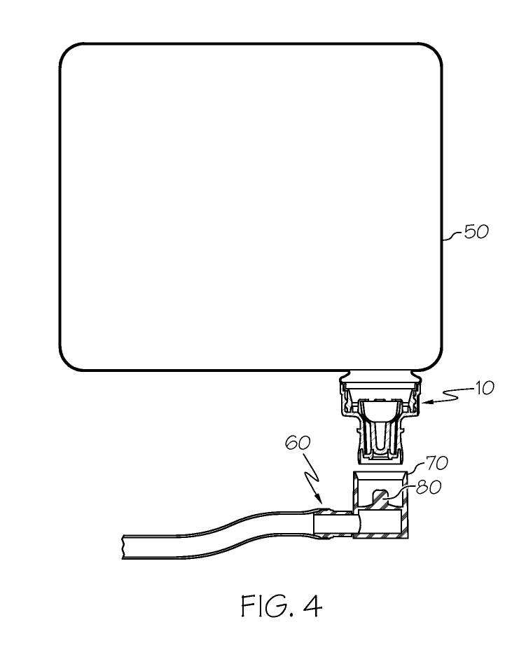

In some embodiments, the housing 14 further comprises an interface cavity 126 (FIG. 3A) for attaching to a container 50 (FIG. 4). With reference to FIG. 4, a container 50 with a dispensing valve 10 in a closed position, in accordance with an embodiment of the present invention, is shown. Container 50 can be a solid container or a semi-rigid container or even a flexible container without departing from the spirit of the disclosure. Screwed onto container 50 is dispensing valve 10, with dust cap 12 having been removed. More particularly, the container 50 comprises an outlet port 74 and an outlet hub 52 which threadingly engages the threads 30 defined by the interface cavity 126 of the housing 14. Container 50 is shown being lowered onto a fluid dispensing line 60. As container 50 is lowered upon container receptacle 70, dispensing valve 10 will engage actuator 80.

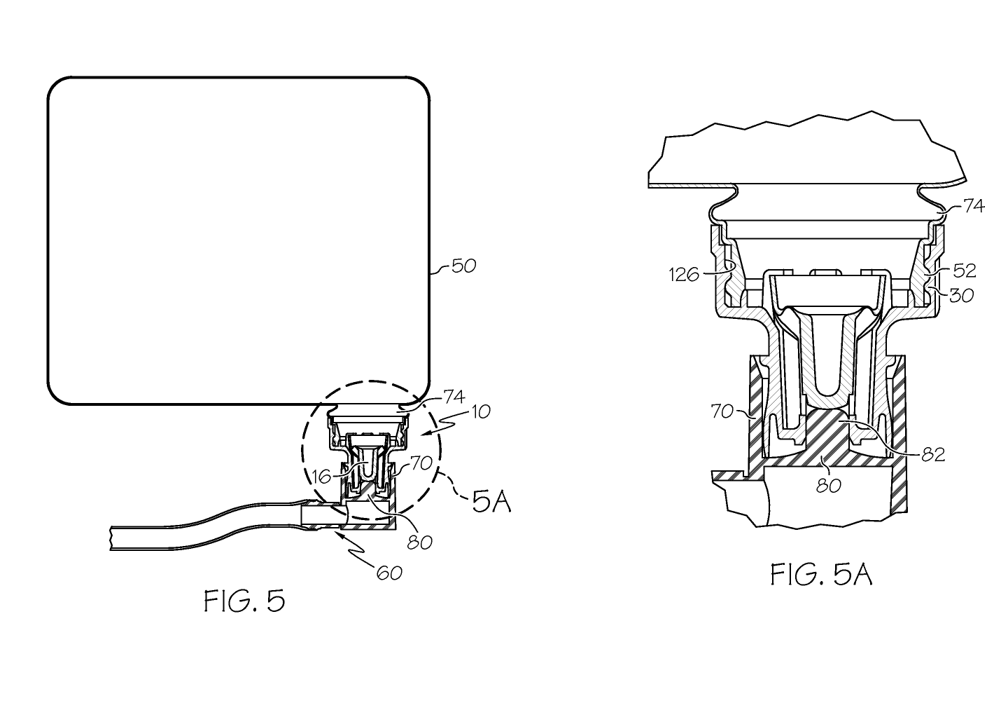

Turning to FIGS. 5 and 5A, the outlet hub 52 is shown attached to the interface cavity 126, for example, by way of threads 30. In particular, the dispensing valve 10 is threaded onto the hub 52 by rotating the housing 14 with respect to the outlet hub 52.

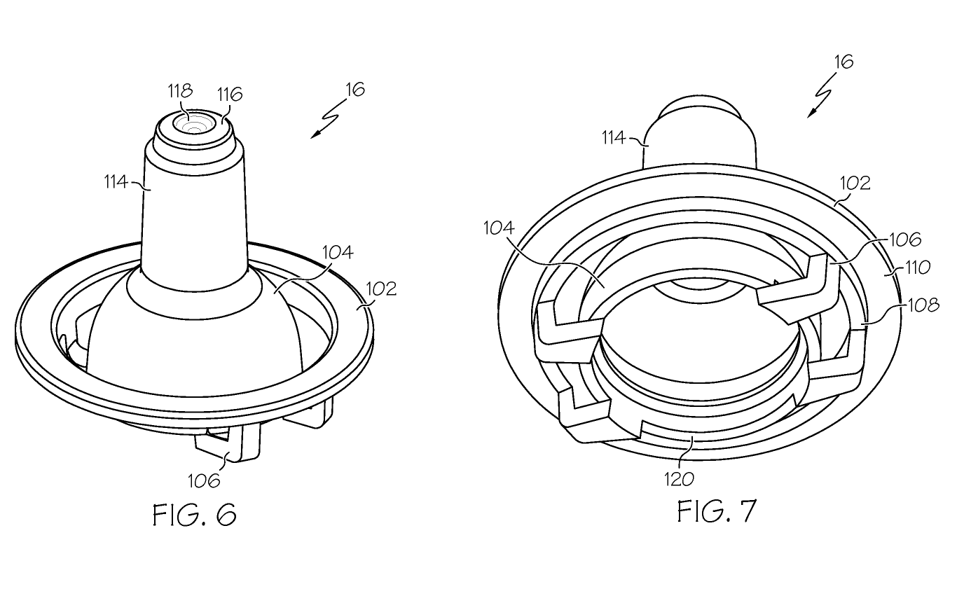

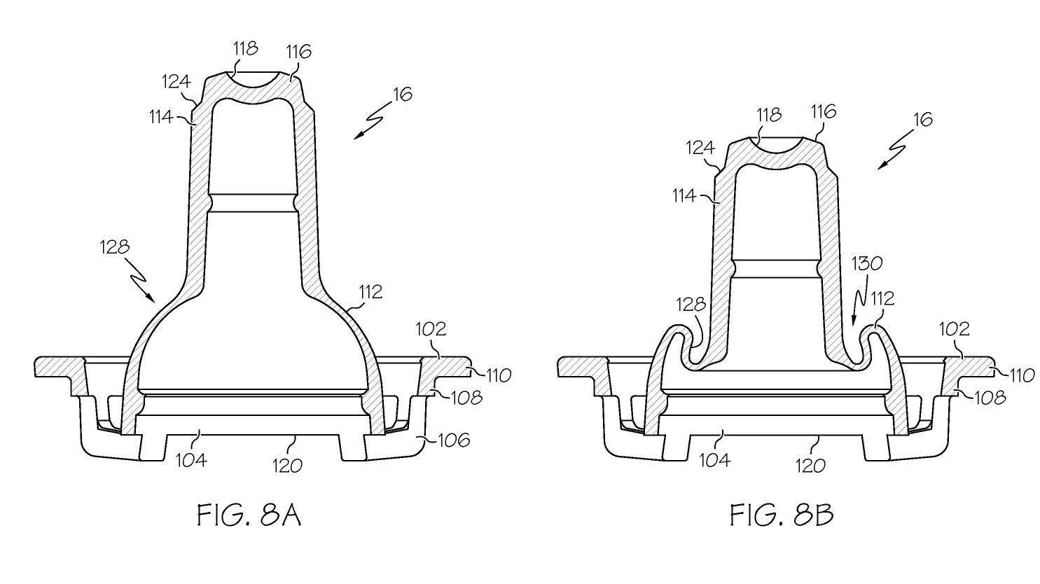

With further reference to FIGS. 5 and 5A, a container 50 with a dispensing valve 10, in an open position, is shown. When container 50 is lowered upon container receptacle 70, spring/seal 16 is pressed toward container 50, thus opening sealing point 32 and allowing fluid to flow from container 50 into fluid dispensing line 60. Spring/seal 16 is pressed toward container 50 by seal actuator 80. As shown in FIG. 5A, in some embodiments, the seal actuator 80 comprises a post 82 which presses on the distal end 116 of the spring/seal 16 (FIG. 6), thereby compressing the spring/seal 16. Fluid will flow down dispensing line 60 and the fluid will be dispensed when an operator operates an outside actuator (not shown).

Turning to FIGS. 6-8, an embodiment of the spring/seal or seal 16 is shown therein having a gasket 102. In some embodiments, the spring/seal 16 comprises a resilient member having a base 104 and a stem 114. In some embodiments, the gasket 102 is attached to the base 104 of the seal 16 via one or more standoff members 106. The gasket 102 is concentrically disposed around the base 104 of the seal 16. Further, in some embodiments, for example as shown at least in FIGS. 1, 2, and 6, the base 104 of the seal 16 is dome shaped.

In some embodiments, the gasket 102 comprises an annular ring 108 having a flange 110 extending therefrom. The gasket 102 provides a sealing surface against which the outlet hub 52 is seated. This arrangement produces an additional barrier to leakage of fluid out of the interface between the outlet hub 52 and the dispensing valve 10.

Furthermore, in some embodiments, for example as shown in FIG. 8A, the seal 16 has a sidewall 112 that is non-uniform in thickness. In particular, the thickness of the sidewall 112 is shaped to facilitate deformation of the seal 16, thereby allowing the dispensing valve to open and close, as desired. In FIG. 8B, the seal 16 shown in a compressed configuration and the valve is open. It will be appreciated that, in some embodiments, the sidewall 112 of the stem 114 is thicker than the sidewall of the base and, in particular, thicker than the sidewall of the dome portion shown at reference numeral 128.

The stem 114 extends from the base 104 and terminates at a distal end 116. In some embodiments, the stem 114 has a frusto-conical shape, having a larger diameter near the base 104 and a smaller diameter nearer the distal end 116. The distal end 116 is closed and, in some embodiments, includes a dished portion 118. The dished portion 118 (FIG. 8A) can align with the post 82 of actuator 80 (FIG. 5A) to compress the seal 16 and permit fluid to flow out of the container 50 and into the receptacle 70 and fluid dispensing line 60 (FIG. 5A).

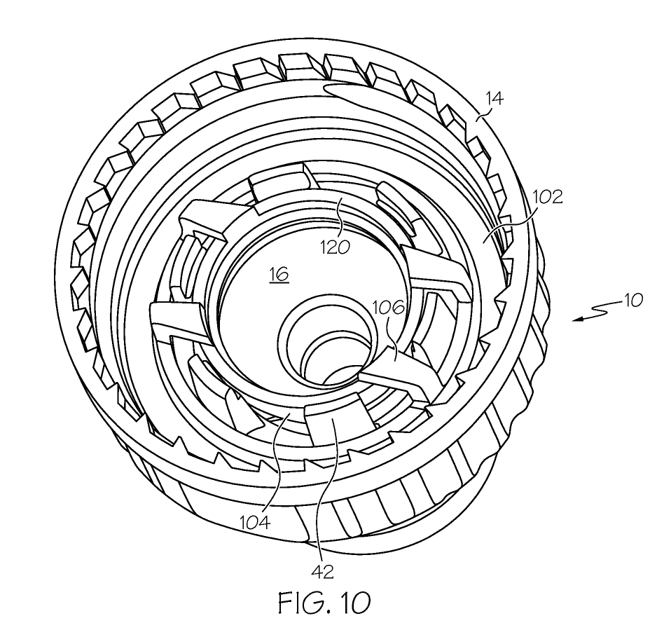

In some embodiments, and with further reference to FIG. 7, the base 104 of seal 16 comprises a proximal end 120. As discussed above, the retaining legs 42 are bent over the proximal end 120 to retain the seal 16 within the housing 14. Where the seal 16 has standoff members 106, the legs 42 are interspersed between standoff members 106 so as not to interfere (FIG. 10) with the standoff members 106 during assembly.

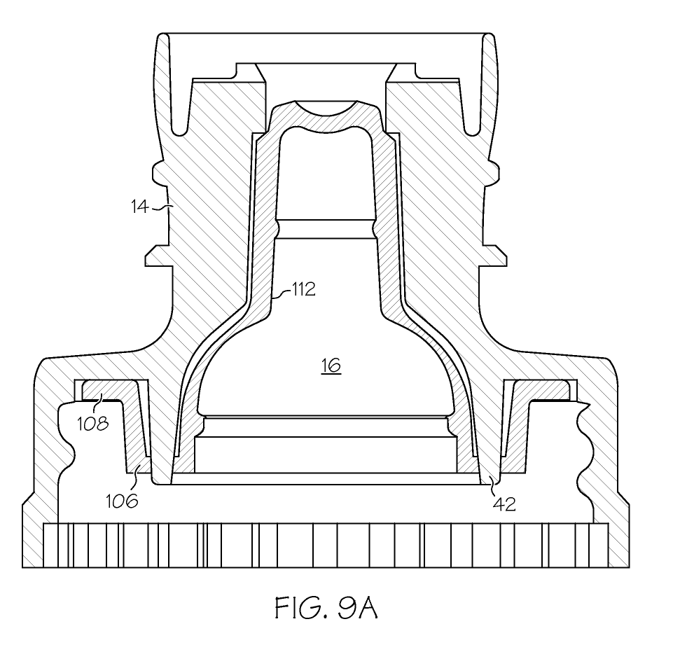

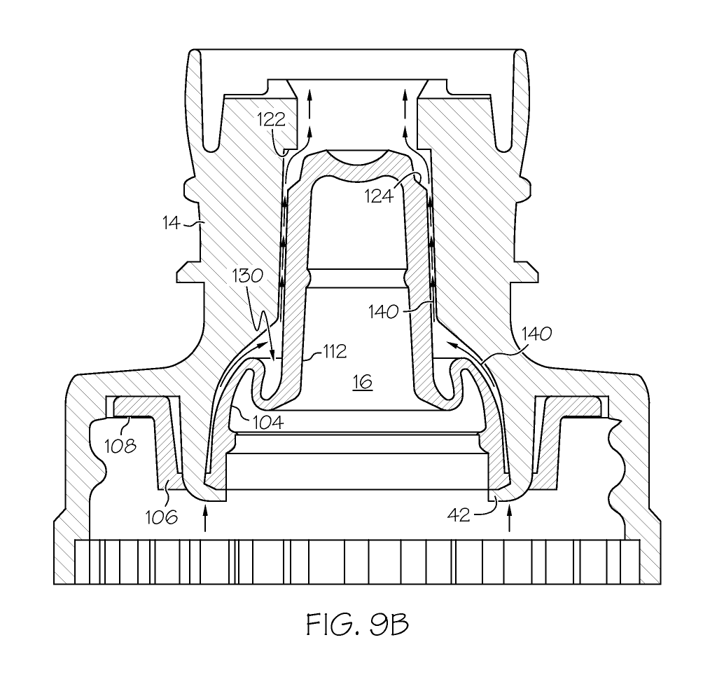

Returning now to FIG. 2A, in some embodiments, a portion of the stem 114 contacts the mating surface 122 of the seal cavity 24 to form a barrier or seal between the spring/seal 16 and the housing 14. As further shown in FIG. 2A, there is an interference fit between the mating surface 122 and the portion of the stem 114 contacting the mating surface 122. The interference fit is illustrated by the overlap of mating surface 122 and stem 114. Further, the portion of the stem 114 that contacts the mating surface 122 of the housing 14 has a beveled surface 124. Because the material of the seal 16 is softer than the material of the housing 14, the beveled surface 124 deforms slightly when the seal 16 is in the extended configuration and the beveled surface 124 is in contact with the mating surface 122. Conversely, as shown in FIG. 9B, when the seal 16 is in a compressed configuration, the stem 114 does not contact the housing 14.

Referring to FIG. 9A, the seal 16 of FIG. 6 is shown inside the housing 14, with the retaining legs 42 in an unfolded configuration. Further, the seal 16 is in the extended or closed position.

Turning to FIG. 9B, when the seal 16 is compressed, for example by post 82 (FIG. 5A), the base 104 elastically deforms to define an annular crease 130. Flow path arrows 140 show the direction of flow of fluid between the seal 16 and the housing 14, when the seal 16 is compressed. Although shown in cutaway in FIG. 9B, fluid is permitted to flow around the retaining legs 42 and between the retaining legs 42 and the seal 16 (FIG. 10).

When the post 82 (FIG. 5A) is removed, the seal 16 returns to the extended position, as shown in FIGS. 2A, 8A, and 9A, and fluid stops flowing.

Finally, turning to FIG. 10, an embodiment of the seal 16 is shown within the housing 14, with the retaining legs 42 in an unfolded configuration. In FIG. 10, it is evident that the retaining legs 42 are interspersed between the standoff members 106. In some embodiments, the seal 16 comprises four standoff members. Any number of standoff members 106 can be used, for example between 1 and 10.

In some embodiments, the seal 16 and gasket 102 are formed in a single injection molding process, thereby creating a unitary structure. In some embodiments, the dust cap 12 and housing 14 are separately formed, for example by injection molding, and are non-unitary. After formation of these constituent components (seal 16, housing 14, and dust cap 12), the seal 16 is inserted into the housing 14. Thereafter, in some embodiments, the retaining legs 42 are folded over the proximal end 120 of the base 104. The dust cap 12 is then added to complete the assembly. As such, in some embodiments, the entire dispensing valve 10 consists of three components.

Thus, embodiments of the FLOW VALVE WITH INTEGRAL SPRING AND SEAL are disclosed. One skilled in the art will appreciate the present teachings can be practiced with embodiments other than those disclosed. The disclosed embodiments are presented for purposes of illustration and not limitation.

What is claimed is:

1. A fluid dispensing valve having an open configuration wherein fluid is permitted to flow and a closed configuration wherein fluid is prevented from flowing, the fluid dispensing valve comprising:
a housing; and
a seal disposed within the housing; the seal comprising a resilient member, the resilient member comprising a base and a stem, the base comprising a dome, the stem extending from the dome and terminating at a closed distal end;
wherein at least a portion of the stem sealingly engages the housing when the fluid dispensing valve is in the closed configuration.

2. The fluid dispensing valve of claim 1, wherein the seal comprises a gasket that is concentrically disposed around the base.

3. The fluid dispensing valve of claim 2, wherein the gasket is attached to the base via a plurality of standoff members.

4. The fluid dispensing valve of claim 1, wherein the dome comprises a sidewall, the sidewall having a variable thickness.

5. The fluid dispensing valve of claim 1, wherein the housing comprises a plurality of retaining legs.

6. The fluid dispensing valve of claim 5, wherein the base comprises a proximal end, the retaining legs being folded over at least a portion of the proximal end of the base.

7. The fluid dispensing valve of claim 1, wherein the seal is moveable between an extended configuration and a compressed configuration and the housing defines a mating surface, in the extended configuration at least a portion of the stem contacts the mating surface and in the compressed configuration the stem does not contact the housing.

8. The fluid dispensing valve of claim 1 further comprising a dust cap, the dust cap having a tear strip.

9. The fluid dispensing valve of claim 1, wherein the stem comprises a frusto-conical portion.

10. The fluid dispensing valve of claim 1, wherein the seal comprises a thermoplastic elastomer material.

11. A fluid dispensing valve comprising:
a housing defining an interface cavity and a seal cavity; and
a seal, the seal comprising a base, a stem extending therefrom, and a gasket attached to the base; the stem disposed within the seal cavity and the gasket disposed within the interface cavity, wherein the stem is moveable within the seal cavity from an extended position to a compressed position; in the extended position, the base being dome-shaped and, in the compressed position, the base being elastically deformed to define an annular crease.

12. The fluid dispensing valve of claim 11, wherein the housing further comprises a plurality of retaining legs and the base comprises a proximal end, the retaining legs being folded over at least a portion of the proximal end of the base.

13. The fluid dispensing valve of claim 11, wherein the housing further comprises internal threads extending into the interface cavity.

14. The fluid dispensing valve of claim 11, wherein the seal comprises a thermoplastic elastomer material.

15. The fluid dispensing valve of claim 11, wherein the base comprises a sidewall, the sidewall having a non-uniform thickness.

16. The fluid dispensing valve of claim 11, wherein the stem comprises a beveled surface and the housing comprises a mating surface, the a portion of the beveled surface contacting the mating surface when the stem is in the extended position.

17. The fluid dispensing valve of claim 11, wherein the stem comprises a distal end, the distal end being dished.

18. The fluid dispensing valve of claim 11 further comprising a dust cap, the dust cap having a tear strip.

19. The fluid dispensing valve of claim 11, wherein the stem comprises a frusto-conical portion.

20. A fluid dispensing assembly:
a container, the container having an outlet hub; and
a fluid dispensing valve, the fluid dispensing valve comprising a housing and a seal, the housing defining an interface cavity and a seal cavity, the housing having a mating surface, the seal disposed within the seal cavity, and the interface cavity defining threads, the threads being threadingly engaged to the outlet hub;
the seal comprising a base and a stem, the base comprising a dome, the stem extending from the dome and terminating at a closed distal end, wherein the stem comprises a beveled surface, the beveled surface of the stem sealingly engaging the mating surface of the seal cavity.
